(19) United States
(12) Patent Application Publication
(10) Pub. No.: US 2020/0358843 A1
(43) Pub. Date: Nov. 12, 2020

(54) SYSTEM AND METHOD FOR DELIVERY OF CONTENT TO A USER DEVICE

(71) Applicant: KING.COM LIMITED, St. Julians (MT)

(72) Inventors: Christian VIELMA, Barcelona (ES); Raimon REDONDO, Barcelona (ES)

(21) Appl. No.: 16/406,708

(22) Filed: May 8, 2019

(51) Int. Cl. H04L 29/08

(52) U.S. Cl. CPC H04L 67/10; H04L 67/306

(57) ABSTRACT

A computer implemented method comprises receiving data about a first condition associated with an apps for a first user. It is determined if one or more sets of required conditions are respectively satisfied by the first condition and at least one stored condition. Each set of conditions is associated with content delivery. When a set of conditions is satisfied, the associated content is delivered to a first user device for the first user.

### FIELD OF THE INVENTION

The present application relates to a computer implemented method and a computer system and in particular but not exclusively to a system and method for delivery of content. The content may be delivered to a user device.

### BACKGROUND OF THE INVENTION

The advent of the internet, and other wide area networks, has led to a proliferation of connected user or client devices, typically running services and associated installations from providers of the user's choice. Such installations may be referred to as apps. There are many different examples of apps such as gaming apps, social apps, entertainment apps, music apps, navigation apps, health apps and many other types of apps.

One technical challenge relates to the scenario where content is to be delivered to one or more target users when one or more conditions are satisfied in real time. One option is to provide bespoke code for the particular content which is to be delivered to the particular target users when one or more conditions are satisfied. This approach may have the disadvantage that changing one or more of the content, target users and conditions may be difficult and the options for change may be limited.

This patent specification describes not only various ideas and functions, but also their creative expression. A portion of the disclosure of this patent document therefore contains material to which a claim for copyright is made and notice is hereby given: Copyright King.com Limited 2019 (pursuant to 17 U.S.C. 401). A claim to copyright protection is made to all screen shots, icons, look and feel and all other protectable expression associated with the games illustrated and described in this patent specification.

### SUMMARY OF THE INVENTION

According to one aspect, there is provided a computer implemented method comprising: receiving at a computer apparatus data about a first condition associated with one or more computer implemented apps for a first user; in response to receiving the data about the first condition, determining by at least one processor of the computer apparatus if one or more of a plurality of sets of required conditions are respectively satisfied by the first condition and at least one stored condition for the first user, each set of required conditions comprising one or more required conditions, each set of required conditions being associated with the delivery of content; and

causing by the at least one processor first content to be provided to a computer device associated with the first user in response to determining by the at least one processor that all the required conditions of at least one set of required conditions have been satisfied, the first content being associated with the respective set of required conditions which is satisfied.

The method may comprise receiving data about one or more further conditions, and determining by the at least one processor when each condition for which data is received if the respective further condition causes one or more sets of required conditions to be satisfied for a respective user.

The method may comprise receiving data about one or more further conditions, and determining by the at least one processor when each condition for which data is received if the respective further condition causes one or more sets of required conditions to be satisfied for the first user.

The determining by at least one processor of the computer apparatus if one or more of the plurality of sets of required conditions are respectively satisfied by the first condition and at least one stored condition for the first user may be performed in parallel for each of the sets of required conditions.

The method may comprise receiving data about a plurality of first conditions at substantially the same time and determining in parallel for each of the sets of required conditions if a respective set of conditions is satisfied by one or more of the first conditions and at least one stored condition.

The method may comprise storing information about the first condition.

The method may comprise receiving data about a subsequent condition associated with the first user and determining by at least one processor of the computer apparatus if one or more of the plurality of sets of required conditions are respectively satisfied by the subsequent condition and at least one stored condition for the first user, at least one stored condition being the stored first condition.

The method may comprise, when the first condition is a required condition of a respective set of required conditions and not all the required conditions of a respective set of required conditions have been satisfied, causing the first condition to be a stored condition for a subsequent determining by the at least one processor.

The method may comprise storing expiry information for at least one stored condition.

The expiry information may indicate one or more of a length of time for which the respective stored condition is valid and a number of times the condition can be used to satisfy one or more sets of conditions.

The method may comprise generating, for at least one set of required conditions which are satisfied, at least one output condition, the at least one output condition comprising a required condition of at least one other set of required conditions.

The method may comprise storing the output condition. The output condition may be stored with expiry information.

The causing by the at least one processor of the providing of the first content may comprise providing an output to a content provider to cause the content provider to provide the first content to the first user.

The output to the content provider may comprise information indicating one or more of the first content to be provided and the first user.

The method may comprise receiving a configuration input, the configuration input comprising information defining the plurality of sets of required conditions.

At least one of the one or more computer implemented apps may comprise a gaming app.

One or more of the conditions may comprise an event.

One or more of the conditions may comprise a fact.

The method may comprise receiving data about one or more conditions from one or more condition providers.

One or more of the condition providers may be configured to provide one or more triggers as a condition.

One or more of the condition providers may be configured to define a set of users of the at least one app, at least one condition of at least one of the plurality of groups of required conditions defining at least a part of the set of users as a condition.

According to another aspect, there is provided a computer implemented method comprising: receiving at a computer apparatus data about a first condition associated with one or more computer implemented apps; in response to receiving the data about the first condition, determining by at least one processor of the computer apparatus if one or more of a plurality of sets of required conditions are respectively satisfied by the first condition and at least one stored condition, each set of required conditions comprising one or more required conditions, each set of required conditions being associated with the delivery of content; and causing by the at least one processor first content to be provided to a computer device associated with a first user in response to determining by the at least one processor that all the required conditions of at least one set of required conditions have been satisfied, the first content being associated with the respective set of required conditions which is satisfied.

According to another aspect, there is provided a computer implemented method comprising: receiving at an input to a computer apparatus, an input indicating content which is to be provided in one or more computer implemented apps, a set of eligible users and a set of conditions to be satisfied in order to provide the content; and generating, by at least one processor of the computer apparatus, from the input a computer model which comprises for each content a set of input conditions to be satisfied to provide the content and for at least one content, one or more output conditions providing one or more input conditions for one or more other sets of input conditions for a respective different content.

The method may comprises providing by the at least one processor an output, the output comprising for each content a set of required conditions.

The method may comprise providing by the at least one processor an output to be provided to one or more providers, the output causing a respective provider to provide one or more of the required conditions.

According to another aspect, there is provided a computer apparatus comprising: an input configured to receive data about a first condition associated with one or more computer implemented apps for a first user; and at least one processor configured to, in response to receiving the data about the first condition, determine if one or more of a plurality of sets of required conditions are respectively satisfied by the first condition and at least one stored condition for the first user, each set of required conditions comprising one or more required conditions, each set of required conditions being associated with the delivery of content and cause first content to be provided to a computer device associated with the first user in response to determining by the at least one processor that all the required conditions of at least one set of required conditions have been satisfied, the first content being associated with the respective set of required conditions which is satisfied.

The computer apparatus may comprise at least one processor and at least one memory including computer code for one or more programs.

The apparatus may be configured to receive via the input, data about one or more further conditions, and the at least one processor may be configured when each condition for which data is received if the respective further condition causes one or more sets of required conditions to be satisfied for a respective user.

The apparatus may be configured to receive via the input, data about one or more further conditions, and the at least one processor may be configured when each condition for which data is received if the respective further condition causes one or more sets of required conditions to be satisfied for the first user.

The at least one processor may be configured to perform the determining if one or more of the plurality of sets of required conditions are respectively satisfied by the first condition and at least one stored condition for the first user in parallel for each of the sets of required conditions.

The input may be configured to receive data about a plurality of first conditions at substantially the same time and the at least one processor may be configured to determine in parallel for each of the sets of required conditions if a respective set of conditions is satisfied by one or more of the first conditions and at least one stored condition.

The apparatus may comprise at least one memory configured to store information about the first condition.

The input may be configured to receive data about a subsequent condition associated with the first user and the at least one processor may be configured to determine if one or more of the plurality of sets of required conditions are respectively satisfied by the subsequent condition and at least one stored condition for the first user, at least one stored condition being the stored first condition.

The at least one processor may be configured to, when the first condition is a required condition of a respective set of required conditions and not all the required conditions of a respective set of required conditions have been satisfied, to cause the first condition to be a stored condition for a subsequent determining by the at least one processor.

The at least one memory may be configured to store expiry information for at least one stored condition.

The expiry information may indicate one or more of a length of time for which the respective stored condition is valid and a number of times the condition can be used to satisfy one or more sets of conditions.

The at least one processor may be configured to generate, for at least one set of required conditions which are satisfied, at least one output condition, the at least one output condition comprising a required condition of at least one other set of required conditions.

The at least one memory may be configured to store the output condition. The output condition may be stored with expiry information.

The at least one processor may be configured to cause an output to be provided to a content provider to cause the content provider to provide the first content to the first user.

The output to the content provider may comprise information indicating one or more of the first content to be provided and the first user.

The input may be configured to receive a configuration input, the configuration input comprising information defining the plurality of sets of required conditions.

At least one of the one or more computer implemented apps may comprise a gaming app.

One or more of the conditions may comprise an event.

One or more of the conditions may comprise a fact.

The input may be configured to receive data about one or more conditions from one or more condition providers.

One or more of the condition providers may be configured to provide one or more triggers as a condition.

One or more of the condition providers may be configured to define a set of users of the at least one app, at least one condition of at least one of the plurality of groups of required conditions defining at least a part of the set of users as a condition.

According to another aspect, there is provided a computer apparatus comprising: an input configured to receive, an input indicating content which is to be provided in one or more computer implemented apps, a set of eligible users and a set of conditions to be satisfied in order to provide the content; and at least one processor configured to generate, from the input a computer model which comprises for each content a set of input conditions to be satisfied to provide the content and for at least one content, one or more output conditions providing one or more input conditions for one or more other sets of input conditions for a respective different content.

The computer apparatus may comprise at least one processor and at least one memory including computer code for one or more programs.

The at least one processor may be configured to provide an output, the output comprising for each content a set of required conditions.

The at least one processor may be configured to provide an output to be provided to one or more providers, the output causing a respective provider to provide one or more of the required conditions.

According to another aspect there is provided an apparatus comprising at least one processor and at least one memory including computer code for one or more programs, the at least one memory and the computer code configured, with the at least one processor, to cause the apparatus at least to: receive data about a first condition associated with one or more computer implemented apps for a first user; in response to receiving the data about the first condition, determine if one or more of a plurality of sets of required conditions are respectively satisfied by the first condition and at least one stored condition for the first user, each set of required conditions comprising one or more required conditions, each set of required conditions being associated with the delivery of content; and cause first content to be provided to a computer device associated with the first user in response to determining by the at least one processor that all the required conditions of at least one set of required conditions have been satisfied, the first content being associated with the respective set of required conditions which is satisfied.

According to another aspect there is provided an apparatus comprising at least one processor and at least one memory including computer code for one or more programs, the at least one memory and the computer code configured, with the at least one processor, to cause the apparatus at least to: receive an input indicating content which is to be provided in one or more computer implemented apps, a set of eligible users and a set of conditions to be satisfied in order to provide the content; and generate, by at least one processor of the computer apparatus, from the input a computer model which comprises for each content a set of input conditions to be satisfied to provide the content and for at least one content, one or more output conditions providing one or more input conditions for one or more other sets of input conditions for a respective different content.

According to some aspects, there is provided a program product comprising a computer-readable storage device including a computer-readable program for providing a computer-implemented game, wherein the computer-readable program when executed on a computer causes the computer to perform any one or more of the method steps described previously.

According to another aspect, there is provided a computer readable non-transitory storage medium carrying one or more computer executable instructions which when run on at least one processor cause any of the preceding methods to be performed.

A computer program comprising program code means adapted to perform the method(s) may also be provided. The computer program may be stored and/or otherwise embodied by means of a carrier medium.

According to another aspect, there is provided a non-transitory computer readable medium encoded with instructions for controlling a computer device having a display, in which the instructions when executed on a processor enable the processor to execute the steps of: receiving data about a first condition associated with one or more computer implemented apps for a first user; in response to receiving the data about the first condition, determining if one or more of a plurality of sets of required conditions are respectively satisfied by the first condition and at least one stored condition for the first user, each set of required conditions comprising one or more required conditions, each set of required conditions being associated with the delivery of content; and causing first content to be provided to a computer device associated with the first user in response to determining by the at least one processor that all the required conditions of at least one set of required conditions have been satisfied, the first content being associated with the respective set of required conditions which is satisfied.

According to another aspect, there is provided a non-transitory computer readable medium encoded with instructions for controlling a computer device having a display, in which the instructions when executed on a processor enable the processor to execute the steps of: receiving an input indicating content which is to be provided in one or more computer implemented apps, a set of eligible users and a set of conditions to be satisfied in order to provide the content; and generating from the input a computer model which comprises for each content a set of input conditions to be satisfied to provide the content and for at least one content, one or more output conditions providing one or more input conditions for one or more other sets of input conditions for a respective different content.

In the above, many different embodiments have been described. It should be appreciated that further embodiments may be provided by the combination of any two or more of the embodiments described above.

### BRIEF DESCRIPTION OF THE DRAWINGS

To understand some embodiments, reference will now be made by way of example only to the accompanying drawings, in which:

FIG. 1a shows an overview of some embodiments;

FIG. 1b shows a block diagram of some embodiments;

FIG. 1c schematically shows an arrangement with which the system of FIGS. 1a or 1b may be used;

FIG. 2 shows one example of the functions of the composer of FIGS. 1a and 1b;

FIG. 3 shows one example of the functions of the core of FIGS. 1a and 1b;

FIG. 4 shows one example of the first supporting services of FIGS. 1a and 1b;

FIG. 5 shows one example of the second supporting services of FIGS. 1a and 1b;

FIG. 6 shows schematically one example of input provided via the composer;

FIG. 7 shows one example of the operation of the engine with a model provided by the core on the left hand side and the functions provided by the engine on the right hand side:

FIG. 8 schematically shows the operation of the keys of the engine;

FIG. 9 schematically shows a single execution case;

FIG. 10 schematically shows a parallel execution case;

FIG. 11 schematically shows a sequence execution case;

FIG. 12 schematically shows a first split case;

FIG. 13 schematically shows a second split case;

FIG. 14 schematically shows an iteration case;

FIG. 15 schematically shows a time constrained case;

FIG. 16 shows a method of some embodiments; and

FIG. 17 shows another method of some embodiments.

### DETAILED DESCRIPTION OF SOME EMBODIMENTS

In the following description of various embodiments, reference is made to the accompanying drawings which form part thereof, and in which is shown by way of illustration various implementations in which some embodiments may be utilized. It is to be understood that the other implementations may be utilized, and structural and functional modifications may be made without departing form the scope of the present invention.

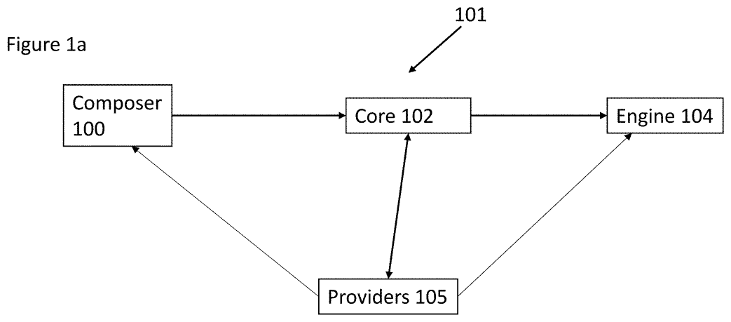

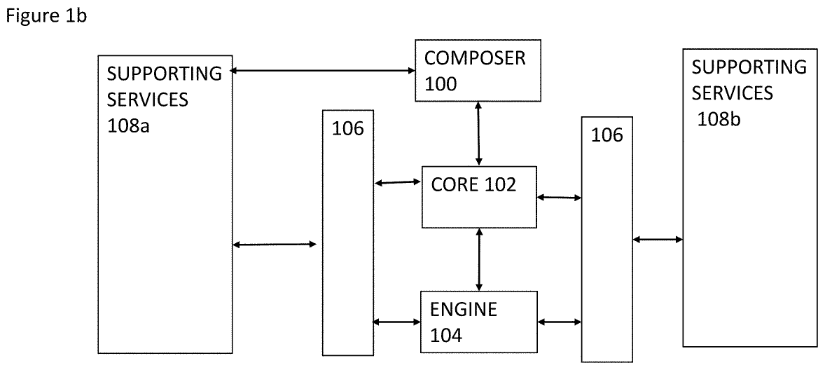

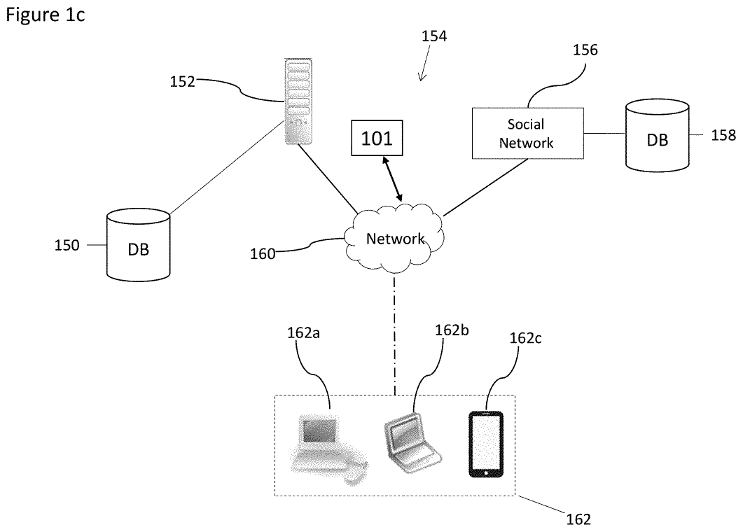

Reference is made to FIG. 1 a which shows an overview of a system 101 of some embodiments. A composer 100 is provided which is configured to communicate with a core 102. The core 102 is also configured to communicate with an engine 104. Providers 105 are provided and interact with the composer, core and engine.

In embodiments a design user will interact with the composer. This is to determine, for example, what content is provided to a particular end user device. For example an end user may be interacting with an app which is running on the end user device. The end user app may be any suitable app. By way of example only, the app may be a gaming app. In the following example, reference is made to a gaming app. However, it is should be appreciated that this is by way of example only and embodiments may alternatively or additionally be used with any other app running on an end user app.

Some embodiments may provide a multi-tier architecture. The composer provides a designer user interface, the core provides an orchestration/conversion function and the engine provides an execution function. As will be described in more detail, the core translates the input provided via the composer into an agnostic execution model. The engine then executes that model.

The system is provided by hardware comprising at least one or more computer devices. The computer device may be any suitable computer device having at least one processor and at least one memory. The one or more computer devices may comprise one or more servers. In some embodiments, the engine may be provided by a computer device cluster. The cluster may comprise a cluster of servers or the like. In other embodiments, the engine may be provided in a single computing device. The core may be provided in the same cluster or device as the engine or in one or more different computer devices. The composer may be provided in the same cluster or device as the engine and/or the core. In some embodiments, the composer may be a separate computer device which is configured to communicate with the core via a network.

The providers may be used in a decoupled way. The core may prepare or configure the providers so that during execution by the engine, the providers may send agnostic information to the engine or execute orders from the engine based on their specialization. The providers may be implemented using one or more computer devices or a computer device cluster. The providers may be implemented by the same cluster or device as one or more of the engine, the core and the composer and/or in one or more different computer devices. Different providers may be implemented by different computer devices.

Reference is made to FIG. 1b which shows one example of a system of some embodiments. First supporting services 108a and second supporting services 108b are provided which may comprise one or more providers. This will be described in more detail later. The supporting services 108a and 108b are configured to communicate with the core 102 and/or engine 104 via a stream processing software platform 106 or other suitable interconnect. The composer 100 is configured to communicate with the first supporting services 108a. The core 102 and the engine 104 may communicate via the stream processing software platform 106.

The composer may provide a single design user interface which operates all the activities happening within an app. An activity may have a set of one or more conditions which when satisfied cause one or more actions. An action may comprise delivery of a particular content and/or an output required as a condition by one or more activities.

In some embodiments, the activities may have a structure that may comprise one or more of an audience, a schedule, an experience and optionally an experiment.

The activities may have use a single terminology and have a common way to operate.

There may be a plurality of types of providers that can be selected based on the activity.

As mentioned, the system may support an activity. For example, an activity may be a single or multiple orchestrated set of deliverables (e.g. content) to be distributed to an audience and scheduled at a specific moment in time and/or under specific circumstances (when).

An activity may be associated with one or more activity properties. The activity properties may be provided by metadata related to the activity. The activity properties may include one or more of information such as name, creator, last update, type/category, and/or the like.

An audience may be the defined population (who) that will receive the deliverables of the activity.

Scheduling may be the defined time and/or conditions (when) that trigger the activity and recurrence of it.

Experience may be what the audience receives and optionally the necessary information to deliver it (sub-schedule) and/or the conditions to deliver it in the correct stream (sub-audience). The experience may use content providers, responsible for the contents and configurations.

An activity experience may be a single or orchestrated set of deliverables that the intended audience will receive under specific conditions. An activity can have as many deliverables as necessary. The deliverables can be evaluated on their own.

Experiments may allow an experience to be tested with different cases. This may have variations as regards to one or more of content, audience and schedule.

An activity experiment may allow a split of the activity audience into different cases to experiment with variations of the experience to understand for example which one performs best. An activity experiment provider will supply the algorithms to split the audience. This may be used for testing such as A/B testing for example.

Providers may supply the necessary information for each part of an activity. This information may be provided such that the system that take care of interpreting and orchestrating the activity. Those providers may be different types and help to contextualise the activity.

A provider may be an application or system that help to compose the fundamental parts of an activity (who, what, when . . . ) and contextualise it.

There may be different provider types. Each provider type may be dedicated to a part of the activity. Providers may be considered to be an input provider or an output provider. An input provider will provide, for example, user IDs (users) to the system based on conditions (belong to audience, triggered a behaviour, received a content, and/or the like). An input provider will output to the system, which delivers a content for a specific user. Some examples of providers will now be described.

An audience provider establishes the base target of users that are eligible to receive content. The intended target group for an activity may be referred to an activity audience.

A schedule provider organises the moment at which the different deliverables should be received, under which condition, and/or the like. The scheduler may set an activity schedule. This may define one or more of the start, the duration and reoccurrence of the activity. This schedule provider may be referred to as a trigger provider. The content provider supplies the media items and configuration that can be used to create a deliverable (texts, videos, liveops, zip files and/or the like).

The experiment provider supplies a framework to experiment and analyse different variants of an experiment or test.

A deliverable is an individual interface element or configuration that is part of an activity. A user of the system may be able to select among different content providers. There may different types of content providers. A deliverable may be defined by content, channel, schedule and audience.

A so called basic content provider may be configured to provide one or more of: text (optionally including its localisation in other languages); images (optionally including its localisation); videos; sounds; files; and/or the like. The images may comprise static or animated images such as GIFs, PNGs, JPGs, etc. The files may comprise compressed or configuration files such as ZIPs, JSON, and XMLs.

A so called logical content provider may provide a richer content using basic content types. By way of example, the content may be an in-app pop up with different layouts. The content may be a rich message. For example a message may be enriched with images or video and sent through push channel. By way of example, the logical content may alternatively or additionally be one or of: HTML; a live-ops with one or more of support for the different games; configuration of the live ops event and a file delivered.

A deliverable channel may be provided. Content can be sent through one or multiple pipes or channels depending on its type.

In some embodiments basic content may be sent through multiple channels. Logical content types may have a single channel or pre-defaulted to one or more channels. For example, an in-game pop-up is only delivered in the in-game channel.

When a content supports multiple channels, a most common channel may be selected or a different criteria may be used to select one or more channels.

There may optionally be a deliverable schedule. This may depend on the selected deliverable type. Each one may have has its own scheduling properties.

There may optionally be a deliverable audience. This may determine if only a sub-audience of the activity audience should receive this content. This may assist in creating flows between content.

A delivery channel is the means by which the deliverables are sent to the user.

In some embodiments, there may be two types of channels, a logical channel and a physical channel. One or other or both of these channels may be supported by some embodiments. Other embodiments, may simply provide a single delivery option for a given content.

Some examples of physical channels are push channels; in app channels and email channels. An in app channel may be inside the app whereas the push channel pushes messages outside the app. Such a channel could be a social media channel or a messaging app or any suitable channel.

In a logical channel, a user of the system could set a text and let the system decide for the specific user device, which is the best physical channel to send it through. The user of the system may select logic such as most used channel or last active channel.

FIG. 1c schematically shows a system 154 according to an embodiment which is configured to support a computer implemented game. The system 154 comprises a server 152 which may store or be in communication with database 150 which may store game player's details, profiles, statistics etc. In practice, one or more databases 150 may be provided. Where more than one server 152 is provided, the database(s) 152 may be provided in one server 152 or across two or more servers. The server 152 may also have a games data function. This may comprise one or more units of memory to store the computer game program, user behaviour data and a processor to run the games program and process the user behaviour data.

The server 152 may communicate via, for instance, the internet 160 to one or more client or end user devices 162, shown in FIG. 1c by way of example as end user devices 162a, 162b and 162c, and may further provide connections to a social network 156, for example, Facebook™. The social network 156 may also be connected to a database 158 storing social user interaction details, for instance, end user to end user interaction maps, friend lists, location history etc. In practice, one or more databases 158 may be provided.

It should be appreciated that embodiments may be deployed in different system architectures. For example, the computer game may be implemented as a computer game that is stored in the memory of the end user device and is run on the processor of the end user device. However, the server 152 may handle some elements of the game in some embodiments. By way of example only, a Java game applet may be provided to the end user device 162 and the locally running Java applet will generate, for example, the graphics, sounds, and user interaction for the game play on the end user device. Some data may be fed back to the server to allow interaction with other players. The data which is fed back may alternatively or additionally allow scoring and/or cross platform synchronization.

In some embodiments, the game may be implemented as a computer program that is stored in a memory of the system, for example the server, and which runs on a processor of the game server. Data streams or updates are supplied to the end user device to allow the end user device to render and display graphics and sounds in a browser of the end user device. It should be appreciated, however, that such an approach does not necessarily require the use of the Internet. The game can be implemented solely as a computer program that is stored and runs entirely on one of many processors in a remote server, and data streams or updates are supplied to the client device (e.g. tablet, smartphone, etc.) to enable the client to render and display graphics and sounds; this ‘web services’ approach is increasingly common.

The game can be implemented allowing an end user to interact with it in different ways depending on the capabilities of the device which the end user is accessing the game with.

Over the course of players playing the game, data will be produced. This data can for instance be related to a player's game performance or to game information related to a social network to which the game is connected. It is possible to gather this data, store it and make use of it for instance to improve the game.

Data which is collected may be provided to the system 101. When one or more conditions are satisfied, the system 101 may be configured to cause content to be delivered to one or more user devices via the game server 152. The system 101 may communicate with the game server 152 via the network or via a direct connection path.

In some embodiments, one or more elements of the system 101 may be provided by the server 152 or the server may be part of the system 101.

FIG. 1c shows an example where the system 101 is used is used in the context of a gaming application. The system may be used alternatively or additionally with any other non-gaming application or app. In some embodiments, the same system may be used to support a plurality of different applications.

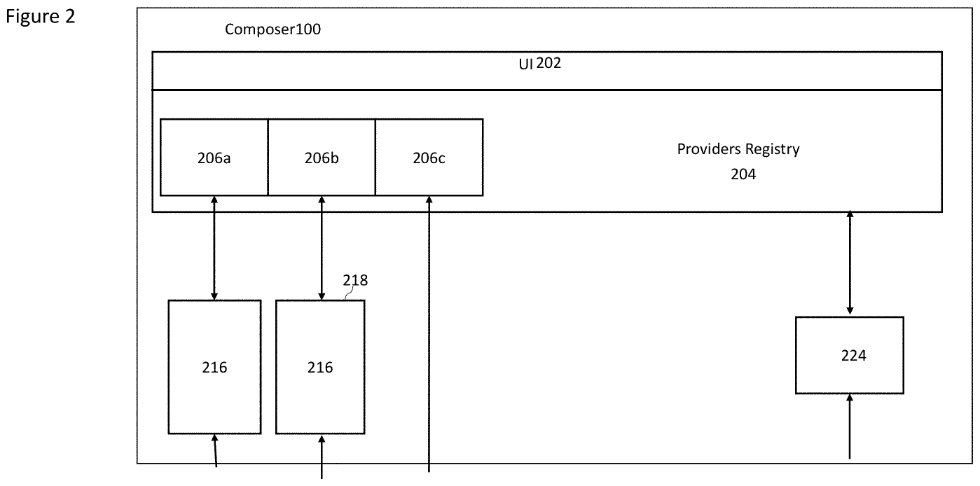

One example of the functions of the composer 100 will now be described in more detail with reference to FIG. 2. The composer provides a set of services and/or modules that provide support to a design user facing application. The composer allows the design user to create activities and/or compose content flows.

The composer comprises a design interface UI module 202. The UI module may be considered to be the design user facing part of the application, with all the components added by providers. The providers may be integrated into the UI as a hard dependency or in a dynamic manner. For example, the provider bundle may be in a CDN (content delivery network) and the UI knows the associated location.

The user interface module comprises a provider registry 204. The provider registry 204 has a list of available providers 206a to 206c. In practice, there may be more than the three providers shown by way of example only.

For each provider, the provider registry 204 may store one or more or all of the following information: provider ID; provider name; provider type; and provider location. The provider location may comprise a URL (universal resource locator) or the like of the UI bundle to be downloaded.

A list of available providers for a given user and workspace may be retrieved from a portal app 224. This portal app may interface with the core. This portal app may be optional in some embodiments. In some embodiments, the UI 202 may sync the list in response to changes.

In some embodiments, the providers will handle their own errors.

In some embodiments, each provider may be responsible for the communication with their portal apps or services.

In some embodiments, each provider may be responsible for the managing of the permission of a given design user and workspace.

In some embodiments, the composer may have an interface 216 which enables two way communication between the providers registry and the respective provider. Alternatively one or more provider may communicate directly with the providers registry.

The providers may get access to one or more of: a user token; a user plane service API discovery method (this may be to initialise the API-Clients); context (for example workspace, language and/or the like); and a method to notify the user (for example visual and/or audio notifications)

The information which is provided to the UI from the respective portal apps or providers may be agnostic. For example a given provider may return a single ID which indicates where all the information from a provider is located and which is ready to be used by the core.

In some embodiments, a given process does not need to be transactional. From the interface retrieving a part of the whole configuration for a given activity to the action of persisting this activity configuration, there is no need for this to be transactional. For example, the interface can create a trigger and later on the portal app fails during the process of persisting this information. In this scenario, there is a harmless trigger that may be reused later.

The portal app 224 may be configured to communicate with the UI 202 and with the core. The app may be considered to provide a backend for the design user front end provided by the UI 202. The portal app may call related services to provide information required by a user.

The composer is able to set the different parts of an activity. The composer may allow one or more of the following to be set: activity properties; activity audience; activity schedule; activity experience builder allowing the composing of the user experience for a type of deliverable; and activity experiment.

The composer provided a user interface with which the design user is able to interact. The user interface may be displayed on a display. The user interface may allow the design user interact with the user interface to select one or more of the who, what and when of the activity which is to be provided. In some embodiments, the user interface may allow the design user to select an activity, determine one or more conditions which need to be satisfied in order for the activity to be provided and optionally define which end users (audience) will receive the activity when the conditions are satisfied.

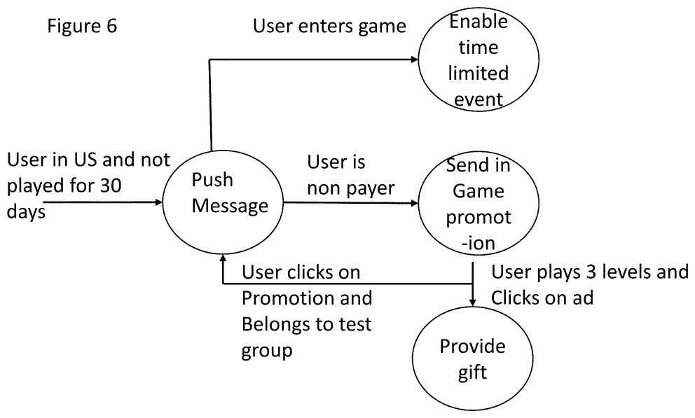

Reference is made to FIG. 6 which shows one example of an input provided via the composer represented schematically. If a user is in the US has not played a game in 30 days, then a push message is provided to that user. If after receiving that push message the end user enters the game, the end user is provided with a time limited game event.

After receiving that push message and the end user is a non-paying game player, the user is sent an in game promotion.

If the user clicks on the promotion and belongs to a test group, then the user will be provide with a push message again.

If the user plays 3 levels and clicks on an ad, then the user is provided with a gift.

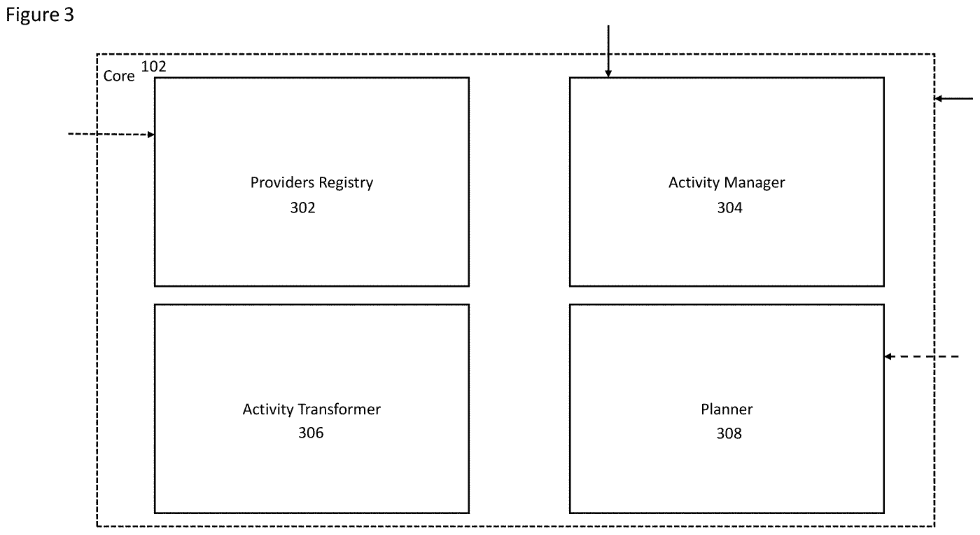

Reference is made to FIG. 3 which shows the core in more detail. The core may be provided as a single entity in some embodiments. In other embodiments, the core may be provided by a plurality of entities.

The core 102 receives user input from the composer 100, coordinates with providers and prepares the engine 104. The core 102 may be responsible for starting and/or stopping activities. The core 102 may communicate with the execution model. The core, based on the input from composer prepares this model, and also communicates with the providers to prepare them for the execution if needed. While the engine is executing an activity (running), the core is no longer involved with that activity (unless the core needs to stop that activity).

The core may be provided with one or more of the following functions: an activity manager function 304; a provider registry function 302; an activity transformer function 306; and a planner function 308. It should be appreciated that this is by way of example and the core functions such as described previously may be implemented using a different function organisation. The one or more functions (which may be one or more of the example functions and/or one or more alternative functions are provided by at least one processor and at least one memory. The at least one processor is configured to run computer code to cause one or more functions to be provided.

The activity manager function 304 provides support for CRUD (create, read, update and delete) operations and/or one or more general activity related tasks. By way of example only, the general activity related tasks may comprise one or more of save, start, stop, delete, update, get monitoring information and/or the like. The activity manager function may be configured to communicate with the composer 100. In some embodiments, the activity manager function is configured to communicate with the UI of the composer via the portal app 224.

The provider registry function 302 maintains an up-to-date list of the available providers. In some embodiments, an approach may be used where providers can send “heartbeats” or notifications of their presence either on demand or periodically to the provider registry function. The provider registry function may keep an up-to-date database of providers. The database stores configuration information and the status of a provider. The provider registry function may determine when a provider is considered enabled or disabled. This may be based on conditions such as a provider has not reported in the last few hours or other suitable duration. One or more providers may be blacklisted and this information about a provider may be stored in the database. In some embodiments, the provider registry function is able to de-duplicate providers which have the same ID or the like.

In some embodiments, authorization information may be associated with one or more providers. This may be stored in the database maintained by the provider registry function. One or more activities may only be associated with one or more providers authorised for that activity. Only suitable authorised providers may be associated with that activity.

The provider registry function may be configured to communicate with supporting services 108a via the stream processing software platform 106. The provider registry function may be configured to communicate with the providers of the supporting service.

The planner function 308 is configured to orchestrate the providers. For example when one or more preconditions apply, the planner function will orchestrate the providers. The one or more preconditions may be any suitable preconditions such as a user starting the activity, the time at which the activity is to be executed and/or the like. The planner may be configured to orchestrate the providers in an agnostic way, and prepare them for execution on the engine.

For example, if a trigger condition is required from a particular provider, that provider will be configured by the core to provide that trigger when it occurs to the engine. The core may specify to the provider what data is to be provided when the trigger occurs and/or the format of the data which is to be provided.

The planner function may not need to understand the whole context of the activity but may needs to know how to individually work with the deliverables. The planner function understands time and behaviour rules.

The providers may be for example one or more of an audience provider, a triggering provider, and a content delivery provider or any other suitable provider.

The planner function may be configured to communicate with the supporting services 108b via the streaming processing software platform or other suitable interconnect.

The activity transformer module 306 may be responsible for translating the flow expressed by the user via the UI of the composer and translate that flow so that the engine can understand and execute that flow.

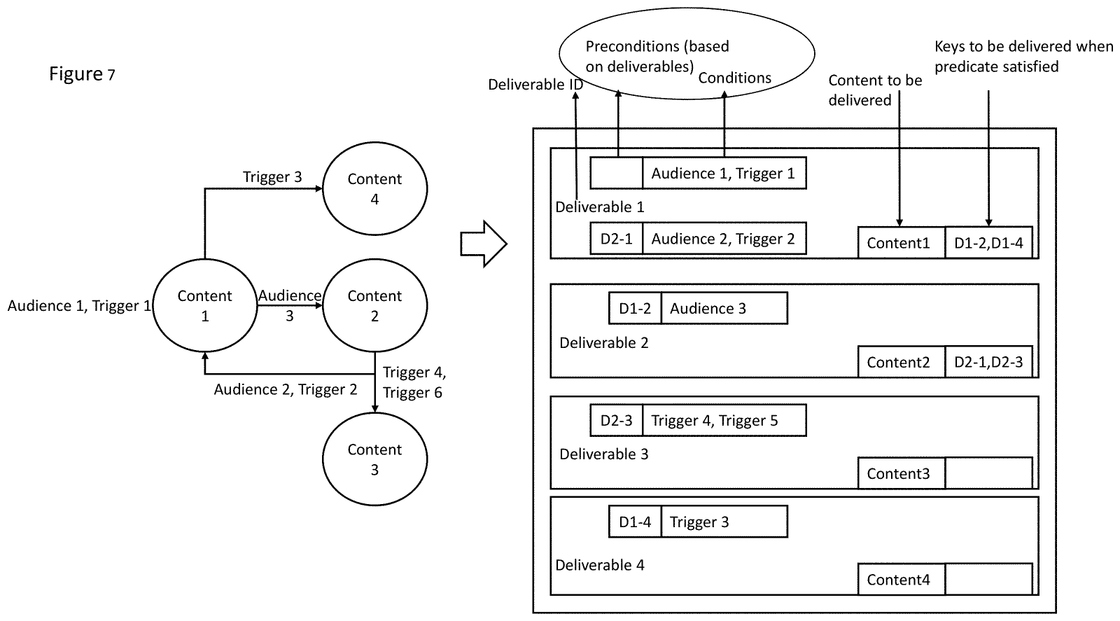

This core takes the input of the composer which is represented schematically in FIG. 6 to the model which is schematically represented by the left hand side of FIG. 7. This will be discussed in more detail later.

The engine 104 listens to specific events in the streaming platform 106 and executes the model to trigger content delivery. The core is configured to ensure that one or more providers are configured to provide the required events or keys.

In some embodiments, there may be additional sources of events. For example, the engine may be configured to send additional events to itself, and/or receive events from the core and/or other systems that are not considered providers. For example: a notification to execute something at a later time, or feedback about something that has to change (e.g. to stop, or one or more additional operations).

The events may produce (or not) an effect on a single activity and user ID.

The engine may have a model related to an activity which can be updated by one single event. This will be described in more detail later.

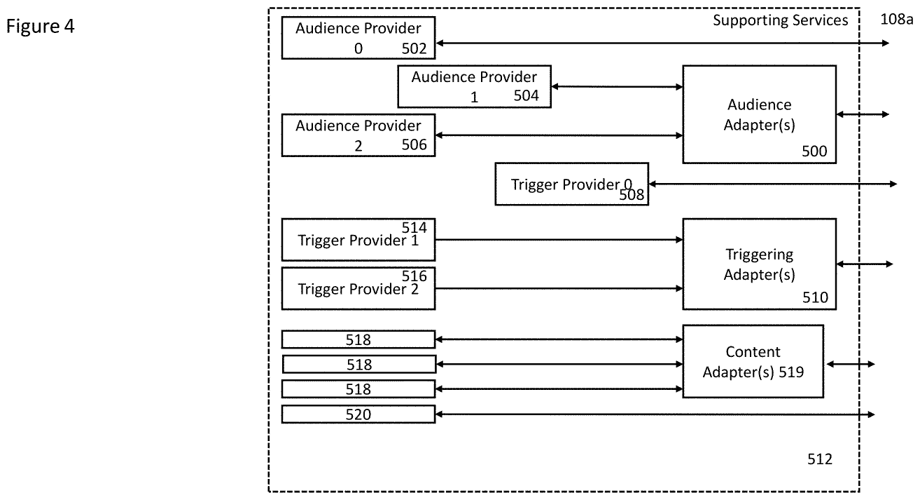

Reference is made to FIG. 4 which shows an example of the first supporting services 108a.

Various different providers may be provided. In the example shown in FIG. 4, there are three audience providers 502, 504 and 506. There are three trigger providers 508, 514 and 516. However, this is by way of example only.

In some embodiments, a provider may be compliant with the system and able to communicate with the streaming platform directly as in the case of one of the audience providers 502 and one of the trigger providers 508.

A provider may not be compliant with the system and communicates with the stream processing software platform via an adaptor or interface. Two of the audience providers 504 and 504 communicate via an adapter or interface 500 with the stream processing software platform or interconnect. Two of the trigger providers 514 and 516 communicate via an adapter of interface 510 with the stream processing software platform or interconnect.

In some embodiments, a provider may be compliant with the composer requirements and able to communicate with the respective provider UI component of the provider registry 204 of the composer without requiring the communications to be via a respective interface.

In some embodiments, a provider may not be compliant with the composer requirements and communicates with the respective provider UI component of the provider registry 204 of the composer via a respective interface.

An input provider such as an audience provider may provide sets of user IDs together with “keys” or identifiers indicated by the system. In the following these IDs are referred as keys. The sets may be provided in real-time. In some embodiments, the provider may send more frequent updates for users when the users join or leave the set. In some embodiments, the updates may be provided on demand.

A trigger provider may be responsible for evaluating conditions for a specific user ID and trigger a response message with a “key” to the system when the conditions are met.

In the some embodiments, the triggers may be simple single action triggers. For example a user has completed a certain level of a computer implemented method. Alternatively or additionally, the triggers may be more complex. For example a user has reached the end of content for a third time in a week. In some embodiment the triggers which are considered to be behavioural triggers are handled separately to time based triggers and/or content based triggers. In other embodiments, the different triggers may be handled together. A behavioural trigger may be on which is caused by a user action on for example a game.

In some embodiments, a template approach may be used. A set of templates may be predefined. One or more placeholders may be modified. For example a template script that produces a message when a level is reached, would have a message placeholder and a level placeholders that may be provided with suitable messages and values respectively.

A REST API may permit one or more of the following actions: create templates; list templates; list placeholders; create trigger from template; activate a trigger; and deactivate a trigger

By way of example only, the steps performed by a trigger component will now be described.

Firstly, the trigger UI component in the provider registry 204 will list the templates.

Once the template is selected at the composer, the trigger provider will return the required placeholders to the UI component via a list placeholder's message.

After filling the required placeholders the trigger provider UI component will creates a trigger from the template.

The UI component will receive an ID referencing this trigger and then send to the core the provider ID and the previous trigger ID.

Inside the core, after the activity transformer function 306 has generated the required one or more keys for the activity, the planner function 308 communicates with the trigger provider to update the trigger to output the right key when the conditions are met.

The planner function will activate the trigger.

The providers may comprise content providers. In some embodiments, the content providers 518 which are not compliant with the system will communicate with the stream processing software platform via an adaptor 519.

One or more of the content providers 520 may be compliant with the system and able to communicate with the stream processing software platform directly.

Content providers may be such that the system knows about what type of content needs to be delivered. The system may not need to communicate much with these types of providers in some embodiments. For example the system may register such a provider and keep track of it.

A content provider may deliver a specific content to a user (associated with a specific user ID) when indicated by the system. When it is time to deliver content, the system will send a message indicating one or more of: a user ID, a content provider ID, a content ID, and a key or identifier. A channel may takes this input and delivers the content to the user.

The provider interfaces may support one or more of the following features:

the communications may be asynchronous;

the providers are able to send messages on receiving a request. The requests may contain one or more keys that may be sent in the associated response;

they are able to read and/or write to standardized topics; and

process requests on a per user ID basis.

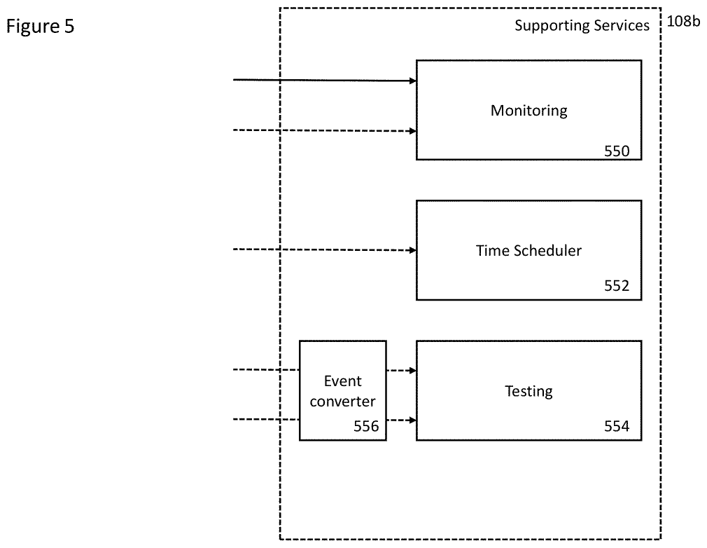

Reference is made to FIG. 5 which shows the second supporting services in more detail. The second supporting service may comprise a monitoring service 550, a time scheduler 552 and a testing service 554. An event converter 556 may be associated with the testing service 554. The monitoring service 550 may be able to read tracking events from the system to be able to report on the execution to devices and users. This monitoring service may have its own interface and/or be called from the core for user reporting.

The time scheduler service may be able to receive “reminder requests” and return “reminders”. The service may allow any system to request that a particular message is sent at a particular time. The service may be asynchronous. The request may comprise one or more a time zone, a time, a message to be sent and a destination to which to send the response.

Based on that information, the scheduler service would be able to do time conversion and send the message at that time.

This scheduler service may be used for a wider range of situations from simple situations such as “start this activity at this time” and/or more complex situations such as “for every user ID that meets a predicate, notify when 3 days have passed for the user”.

The testing service 554 may be provided by any suitable testing framework. In some embodiments, due to the characteristics of the system and the tasks that may be performed, there may a need to query or materialize the population for a specific user ID before sending a content. The testing service may optionally interact with the system via an event convertor 556 acts as a “translator” between the system and the testing service. In some embodiments, the event converter may be omitted.

In some embodiments, there may be a delivery event converter provider. This may be one of the providers. Content and/or channels may trigger specific events when the content is delivered (for example, push sent, push processed, push clicked). When these events are triggered by the system, they are converted to messages which are compatible with the system so that for example these messages can be fed back again to the engine. The engine may, based on these messages, evaluate predicates that were expecting the condition to be met.

The engine 104 will now be described with reference to FIGS. 7 to 15. In some embodiments, a predicate model may be used as opposed to a flow mode in which there is a sequential evaluation of interconnected and dependent steps. In contrast, in the predicates model used in some embodiments, the design user can build simultaneous paths, multiple points of origin, converging paths and paths that go back to the origin. In this type of model each individual item is independent and can be evaluated on its own. For example: “Players that have NOT played level 23” has a Boolean result that can be evaluated on its own.

The engine may be configured to execute a flow for a user based on the facts that it gathers about the user. Each of the steps in the flow may have conditions that once met deliver a content. The flow may have one or more of a plurality of entry points, a plurality of possible steps to be executed at the same time, rules on which flow should be executed (in case not all of them are desired) and loops. The deliverables are independent and can be evaluated on their own. The deliverables have self-contained logic that allows the engine to understand them and the dependencies with other elements. Consider this example of a retargeting flow with a push notification and a push reminder for those user that have not opened it. The second push notification (push222) will be related to the first push notification (push111) through its sub-audience. In its configuration, the sub-audience will be “Not opened push111).

The engine uses keys and locks in some embodiments. The keys and locks model is a way to abstract how to evaluate user conditions (locks) depending on the facts that are known about them (keys). This is differs from, for example, state machines where the facts are obtained first and then the predicates are evaluated. In contrast, in embodiment, all the predicates are first obtained, and then while getting the facts (keys) of the user in real-time, the system of some embodiments can tune how to evaluate the predicates. Embodiments may allow complex flows to be defined via the locks that these keys “open”.

Some embodiments all the logic model (defined by the inputs to the composer) which is provided by the core to be converted to an agnostic model (based on “keys and locks”).

Content is delivered when certain conditions are met. These conditions are referred to as predicates in this document. These conditions are abstracted into a keys and locks model. In some embodiments, the keys may be facts or events given by providers. The providers may be audience providers and/or trigger providers. The locks are the predicates that that the engine needs to check.

Users may have a keyring or state which stores keys. A shared model is provided which has a definition of the locks required. Keys can be regarded as artefacts that are collected by users and provide a way to unlock content.

In some embodiments, the keys may have one or more common attributes. For example the common attributes may comprise one or more of: an ID which may be a unique identifier for the key; and expiration which may be one or more of the date/time when the key is no longer valid.

In some embodiments there are different types of keys that may cause different behaviour. Some different types of keys will now be described.

An audience key may last until expiration and the order it was received may not be crucial during orchestration evaluation. This key may be for a particular segment.

A trigger key may be any suitable type of triggering condition. For example, the triggering condition may be time or behaviour. The trigger key may be time sensitive and/or activity specific. The trigger may be associated with one or more of the following attributes: time, for example the time when this key was acquired by the user; activity ID which may be a unique identifier for the activity to which it belongs to; time dependency of the trigger; or behaviour dependency of the trigger. In the case of time, these keys may be requested by the engine during execution time.

An output/delivery key may be a key generated when a predicate is met and the content for that predicate can be delivered. The output/delivery key may be associated with one or more of the following attributes: time, for example the time when this key was acquired by the user; activity ID which may be an unique identifier for the activity to which it belongs to; deliverable ID which may be a unique identifier for this step in the activity; a next deliverable ID which may be a unique identifier for the deliverable this key also opens or provides. All of the IDs may together form the ID for this type of key.

A spendable key may be a trigger or output/delivery keys that can be used once. Once the key unlocks a predicate, that key is discarded.

A permanent key may be one that stays in the keyring until expiration, without any consideration on how many predicates they unlock. An audience key may be a permanent key.

It should be appreciated that the above described keys are by way of example only and there may be one or more alternative and/or additional keys.

A deliverable can be regarded as the upper layer(s) of the application. A deliverable may be regarded as the union between conditions and content. When the conditions are met the content will be delivered. In the engine model the conditions may be the locks.

In some embodiments, there may be different sets of conditions to deliver the same content.

A predicate may be regarded as set of conditions to deliver a content. Every content may have a plurality of predicates and together form a deliverable. In the predicate there may be preconditions (that can depend on other predicates being satisfied) or not.

In some embodiments, the initial representation of a model is an activity. The flow model from the UI would be converted into a list of predicates. There may be some optimizations for efficient lookup. For example, there may indexing by key, using efficient data structures, caching, and/or the like.

An activity engine model has a set of activities. Each activity may have a plurality of deliverables. Content may get processed when one of their predicates is valid. A predicate to be valid unlocks all the locks associated with that predicate. This model may be immutable and stateless.

Keys in the user's keyring may be sorted in dependence on time. This may allow a happens-before relationship to be set up to determine which predicates can be unlocked (for example, when pre-conditions apply). Tasks that depend on others may have pre-conditions. These preconditions may be met with the corresponding output/delivery key.

In this regard reference is made to FIG. 7. On the left hand side of the Figure is the model which is provided by the core. This model is based on the input provide by the composer shown in FIG. 6. In this example model, the keys Audience 1 (user is in US) and Trigger 1 (user has not played for 30 days) will unlock content 1 (push message). After content 1 has been unlocked, the key Trigger 3 (user enters game) will unlock content 4 (time limited event). After content 1 has been unlocked, the key Audience 3 (user is non-payer) will unlock content 2 (send in-game promotion). After content 2 has been unlocked, the keys Trigger 4 and Trigger 6 (user plays 3 levels and clicks on ad) will unlock content 3 (provide gift). After content 2 has been unlocked, the keys Audience 2 (user is part of test group) and Trigger 2 (user clicks on promotion) will unlock content 1 again. It should be appreciated that this is just one example of a possible model.

In some embodiments, there may be a large number of different models. In some embodiments, one or more of the models may be more complex than the example model. In some embodiments, one or more of the models may be less complex than the example model.

The model on the left hand side is provided to the engine which performs the functions shown on the right hand side based on this model.

Each of content 1 to 4 is associated with a deliverable. For each deliverable the following information may be defined. Firstly each deliverable is provided with a deliverable ID. For each deliverable, any preconditions based on deliverables may be defined along with any conditions. Each deliverable defines the content to be delivered and any keys which are to be delivered to any other deliverable.

The deliverable with the deliverable ID deliverable 1 will provide the content 1. Keys D1-2 and D1-4 need to the delivered to the second and fourth deliverables respectively. There are two sets of pre-conditions and conditions. The first set has no precondition and the conditions are the occurrence of Audience 1 and Trigger 1. The second set has the precondition based on deliverables of key D2-1 provided by the second deliverable. The conditions are the occurrence of Audience 2 and Trigger 2.

The deliverable with the deliverable ID deliverable 2 will provide the content 2. Keys D2-1 and D2-3 need to be delivered to the first and third deliverables respectively. The preconditions based on deliverables is key D1-2 provided by the first deliverable. The condition is the occurrence of Audience 3.

The deliverable with the deliverable ID deliverable 3 will provide the content 3. No keys need to be delivered. The preconditions based on deliverables is key D2-3 provided by the second deliverable. The conditions are the occurrence of Trigger 4 and Trigger 5.

The deliverable with the deliverable ID deliverable 4 will provide the content 4. No keys need to be delivered. The preconditions based on deliverables is key D1-4 provided by the first deliverable. The condition is the occurrence of Trigger 3.

Each of the deliverables is associated with a set of logic or computer program. When a new event or key for a user is received, it is checked to see if the conditions of any of the deliverables are satisfied.

Optionally, where one deliverable is associated with the output of one or more other deliverable, that deliverable logic may not be executed directly and execute at a later time, when the required deliverable(s) are released. This would mean that a new key or event would not be checked with respect to the conditions for that deliverable. However, once that deliverable logic has the necessary keys from one or more other deliverable, then newly received key would be checked by that deliverable logic.

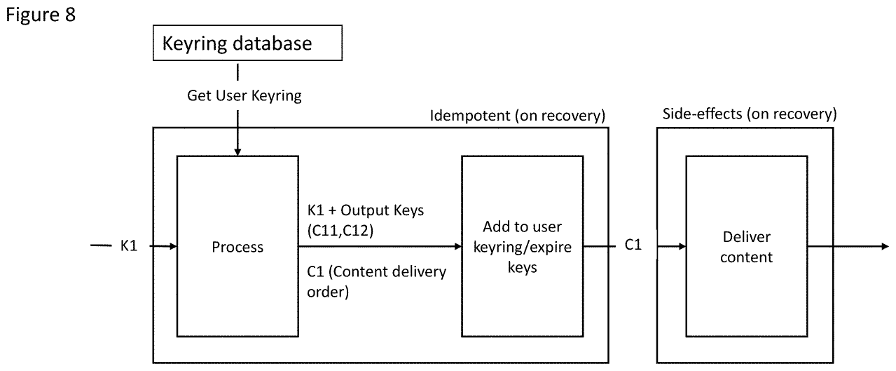

Reference is now made to FIG. 8 which represents the function provided in the engine and as shown in FIG. 7 but from a key management perspective. In some embodiments, events that contain keys which may be idempotent in terms of final user state, but side effects (such as freeing one new key or delivering a content) will not. Idempotent denotes an element of a set which is unchanged in value when multiplied or otherwise operated on by itself.

A shown in FIG. 8, a new key K1 is received as an input to a process. This input key would be associated with a particular end user. The input key may be regarded as being a condition. The input key may be or one of the triggers shown in FIG. 7 and/or or more of the keys which are delivered when the predicate is delivered.

The process also gets an input from the user keyring which is a data store provided in memory. The process may implement computer program code. The keyring for a plurality of different users may be stored using a database structure or in any other suitable storage structure/system. By way of example, each user may have a relatively large number of keys. For example a user might have thousands of keys, perhaps of the order of 10,000 keys. There may be many thousands of users. It should be appreciated that the number of keys of a user and the numbers of users is for illustrative purposes only and different numbers of keys and/or users may be provided in different embodiments.

This keyring will store keys which have been previously received. For example, in the case of the example shown in FIG. 7, the audience keys may (but not necessarily) be provided when a user starts playing a game or before.

The process provides an output of K1 and output keys C11 and C12. (These output keys can be regarded as the keys to be delivered when a predicate is satisfied). The process also provides an output Cl which is the content delivery order. (This may cause the content to be delivered) The output is will add to the user key ring and/or expire keys. This provides an output of Cl which is the delivery of content.

The process which is performed by the engine is schematically illustrated on the right hand side of FIG. 7 as previously described. Thus each time a new key is provided, a check is made to see if any of the conditions associated with any of the deliverables is satisfied. If not the key is stored in the keyring. If so, the deliverable associated with the satisfied conditions is satisfied. The key is stored in the keyring along with any of the generated keys. In some embodiments, the keys may be associated with an expiry. This may be managed by the database.

For example a given key may be only used n times where n is an integer greater than or equal to 1. Each time the key is used, use information is updated so that when the key has been used n times, the key is expired.

Alternatively or additionally, a given key may only be valid for a given time period. When the time period expires, the given key is expired.

In some embodiments an expired key may be deleted from a keyring. In some embodiments, a key which is expired, remains in the keyring but is marked as expired.

In some embodiments, a deliverable may only be delivered once and once that occurs, then the associated logic may be removed or marked as inactive. This would mean that when a key is received, that key would not be checked with respect to the inactive deliverable logic.

It should be appreciated that the activity model as previously described may be shared between users. This may be via a broadcast state.

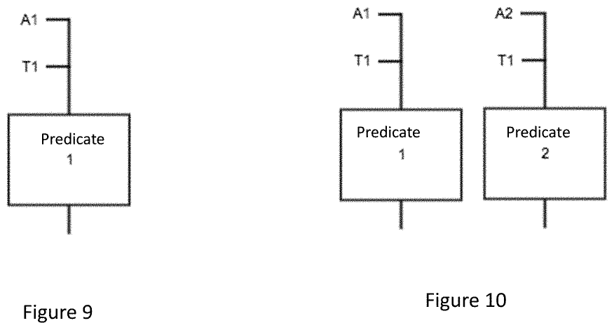

Some examples of how the predicates (using keys and locks) can be evaluated in different circumstances and deliver content will now be described with reference to FIGS. 9 to 15. These cases would be performed as part of the process of FIG. 8. A single execution case will be described in relation to FIG. 9. Given a set of keys one predicate should be unlocked and the content processed. With a set of Keys [A1, T1], this will unlock the predicate 1. A1 may be an audience key and T1 may be a trigger key. A parallel execution case will now be described in relation to FIG. 10. Given a set of keys a plurality of predicates should be unlocked and a plurality of contents processed. With a set of keys [A1, A2], when receiving the key T1 will unlock both predicates 1 and 2. A1 and A2 may be audience keys and T1 may be a trigger key.

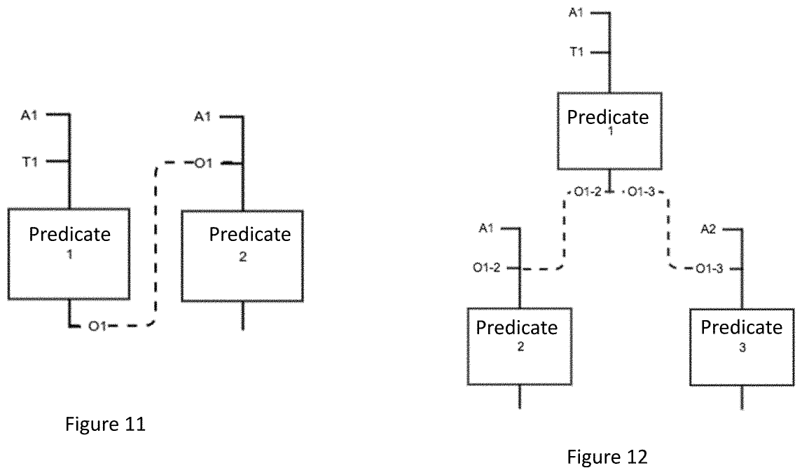

A sequence case will now be described in relation to FIG. 11. Given a set of keys a first predicate 1 is unlocked and the processing of the content generating an output key O1. Adding the output key O1 to the set of keys unlocks a different predicate 2 and processes it. With a set of keys [A1, T1], content 1 will be processed and output key O1 will be generated. Adding this output key to the set [A1, T1, O1] will allow the unlocking of another predicate 2 and content 2 will be processed.

A split case will now be described in relation to FIG. 12. Given a set of keys one predicate 1 should be unlocked and the content processing generates a plurality of output keys. These output keys are added to the set of keys will unlock a plurality of different predicates 2 and 3, and process all of them. With a set of keys [A1, T1], content 1 will be processed and output keys O1-2 and O1-3 will be generated. Adding this output key O1-2 to the set [A1, T1, O1-2] will allow the unlocking of another predicate 2 and content 2 to be processed. Adding this output key O1-3 to the set [A2, T1, O1-2] will allow the unlocking of another predicate 3 and content 3 to be processed.

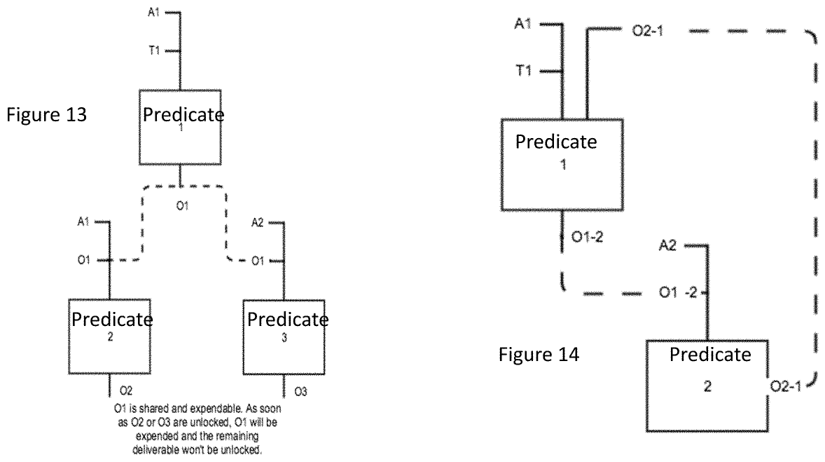

Another split case will now be described with reference to FIG. 13. Given a set of keys, one predicate 1 should be unlocked and the content processed to generate a shared and expendable output key O1. Adding the output key O1 to the set of keys should unlock one predicate 2 or 3 and then that output key be expended. The other predicate(s) depending on that same shared output key should not be unlocked (since it is expended). This may provide a user with the possibility to establish an exclusive paths so it can be one path or the other.

Another split case will now be described. In this example, given a set of keys, one predicate 1 should be unlocked and the content processed to generate an output key O1-2. Adding the output key to the set of keys may unlock a plurality of different predicates but process exactly one of them.

An example having one or more iterations will now be described with reference to FIG. 14. Given a set of keys one predicate 1, is unlocked and the content processed generating an output key O1-2. Adding the output key O1-2 to the set of keys should unlock the same predicate for a defined number of iterations.

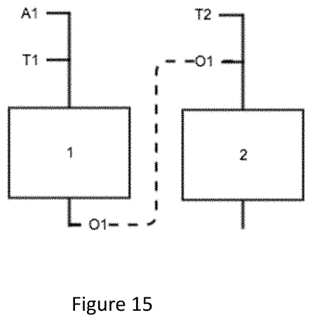

Reference is made to FIG. 15 which shows a time constrained case. Given a set of keys, one predicate 1 should be unlocked and the content processed generating an output key O1. Adding the output key O1 to the set of keys should unlock one predicate 2 but due time constrains the predicate is not processed. T1 and T2 are semantically equals, they have different keys but both of them refer to the same trigger logic.

In other embodiments, the keys T1 and T2 are not semantically the same.

T2 may only be valid if its timestamp is higher than the O1 timestamp.

In some embodiments, predicates may be indexed by keys.

In some embodiments, predicates may be indexed by activities.

In some embodiments, expired keys may be removed or otherwise dealt with.

These expired keys may be from one or more of inactive user states and active users. In the case of keys that are related to contextual triggers (based on the delivery state of a content) these contextual triggers may be abstracted from the execution model and left in the form of a key.

In some embodiments, there may be more than one loop of a flow. There may be flows which can be evaluated as true a plurality of times. In some embodiments, one or more of these types of flow may be provided with a counter which may limit the number of times the loop may be executed.

In some embodiments one or more advantages may be provided. From the viewpoint a user, all the activities of an app will be operated in a single system. In some embodiments, all of the activities will share the same structure. For example, one or more of audience, schedule, experience and experiment related activities may have the same structure. This may allow for complex activities to be achieved. This may allow different parts to be decoupled.

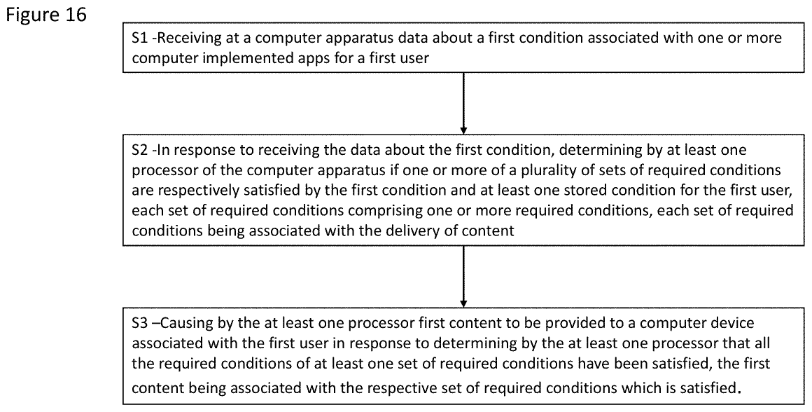

Reference is made to FIG. 16 which shows a method of some embodiments. In step S1, the method comprises receiving at a computer apparatus data about a first condition associated with one or more computer implemented apps for a first user.

In step S2, the method comprises, in response to receiving the data about the first condition, determining by at least one processor of the computer apparatus if one or more of a plurality of sets of required conditions are respectively satisfied by the first condition and at least one stored condition for the first user, each set of required conditions comprising one or more required conditions, each set of required conditions being associated with the delivery of content.

In step S3, the method comprises causing by the at least one processor first content to be provided to a computer device associated with the first user in response to determining by the at least one processor that all the required conditions of at least one set of required conditions have been satisfied, the first content being associated with the respective set of required conditions which is satisfied.

The method of FIG. 16 may be performed in the engine.

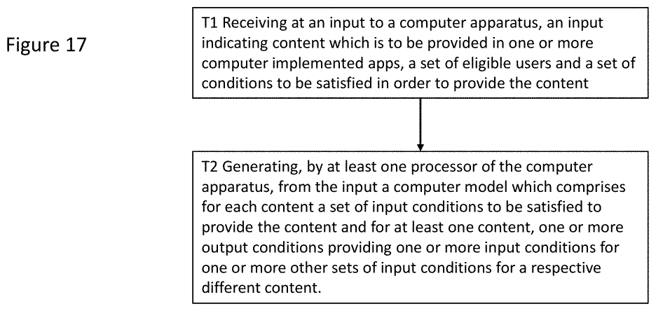

Reference is made to FIG. 17 which shows a method of some embodiments. The method of FIG. 17 may be performed in the core.

In step T1, the method comprises receiving at an input to a computer apparatus, an input indicating content which is to be provided in one or more computer implemented apps, a set of eligible users and a set of conditions to be satisfied in order to provide the content.

In step T2, the method comprises generating, by at least one processor of the computer apparatus, from the input a computer model which comprises for each content a set of input conditions to be satisfied to provide the content and for at least one content, one or more output conditions providing one or more input conditions for one or more other sets of input conditions for a respective different content.

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor. A computer program product may be provided which comprises computer program product comprising code embodied on a computer-readable medium which is configured to be executed on a processor of the computer or user device. In some embodiments, a non-transitory computer readable storage device may be provided to store program code instructions that, when executed by at least one processor causes any of the above described methods to be performed.

It is possible to implement embodiments in a number of variations without departing from the scope of the invention as claimed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method comprising:
receiving at a computer apparatus data about a first condition associated with one or more computer implemented apps for a first user;
in response to receiving the data about the first condition, determining by at least one processor of the computer apparatus if one or more of a plurality of sets of required conditions are respectively satisfied by the first condition and at least one stored condition for the first user, each set of required conditions comprising one or more required conditions, each set of required conditions being associated with the delivery of content; and
causing by the at least one processor first content to be provided to a computer device associated with the first user in response to determining by the at least one processor that all the required conditions of at least one set of required conditions have been satisfied, the first content being associated with the respective set of required conditions which is satisfied.

2. The computer implemented method of claim 1, comprising receiving data about one or more further conditions, and determining by the at least one processor when each condition for which data is received if the respective further condition causes one or more sets of required conditions to be satisfied for a respective user.

3. The computer implemented method of claim 1, wherein the determining by at least one processor of the computer apparatus if one or more of the plurality of sets of required conditions are respectively satisfied by the first condition and at least one stored condition for the first user is performed in parallel for each of the sets of required conditions.

4. The computer implemented method of claim 1, comprising receiving data about a plurality of first conditions at substantially the same time and determining in parallel for each of the sets of required conditions if a respective set of conditions is satisfied by one or more of the first conditions and at least one stored condition.

5. The computer implemented method of claim 1, comprising storing information about the first condition.

6. The computer implemented method of claim 5, comprising receiving data about a subsequent condition associated with the first user and determining by at least one processor of the computer apparatus if one or more of the plurality of sets of required conditions are respectively satisfied by the subsequent condition and at least one stored condition for the first user, at least one stored condition being the stored first condition.

7. The computer implemented method of claim 1, when the first condition is a required condition of a respective set of required conditions and not all the required conditions of a respective set of required conditions have been satisfied, causing the first condition to be a stored condition for a subsequent determining by the at least one processor.

8. The computer implemented method of claim 1, comprising storing expiry information for at least one stored condition.

9. The computer implemented method of claim 8, wherein the expiry information indicates one or more of a length of time for which the respective stored condition is valid and a number of times the condition can be used to satisfy one or more sets of conditions.

10. The computer implemented method of claim 1, comprising generating, for at least one set of required conditions which are satisfied, at least one output condition, the at least one output condition comprising a required condition of at least one other set of required conditions.

11. The computer implemented method of claim 10, comprising storing the output condition.

12. The computer implemented method of claim 1, wherein the causing by the at least one processor of the providing of the first content comprises providing an output to a content provider to cause the content provider to provide the first content to the first user.

13. The computer implemented method of claim 12, wherein the output to the content provider comprises information indicating one or more of the first content to be provided and the first user.

14. The computer implemented method of claim 1, comprising receiving a configuration input, the configuration input comprising information defining the plurality of sets of required conditions.

15. The computer implemented method of claim 1, wherein one or more of the conditions comprises an event.

16. The computer implemented method of claim 1, comprising receiving data about one or more conditions from one or more condition providers.

17. The computer implemented method of claim 16, comprising receiving one or more triggers as a condition from one or more of the condition providers.

18. The computer implemented method of claim 16, wherein one or more of the condition providers is configured to define a set of users of the at least one app, at least one condition of at least one of the plurality of groups of required conditions defining at least a part of the set of users as a condition.

19. A computer implemented method comprising:
receiving at an input to a computer apparatus, an input indicating content which is to be provided in one or more computer implemented apps, a set of eligible users and a set of conditions to be satisfied in order to provide the content; and
generating, by at least one processor of the computer apparatus, from the input a computer model which comprises for each content a set of input conditions to be satisfied to provide the content and for at least one content, one or more output conditions providing one or more input conditions for one or more other sets of input conditions for a respective different content.

20. The computer implemented method as claimed in claim 19, comprising providing by the at least one processor an output, the output comprising for each content a set of required conditions.

21. The computer implemented method as claimed in claim 20, comprising providing by the at least one processor an output to be provided to one or more providers, the output causing a respective provider to provide one or more of the required conditions.

22. A non-transitory computer readable medium encoded with instructions for controlling a computer device having a display, in which the instructions when executed on a processor enable the processor to execute the steps of:
receiving data about a first condition associated with one or more computer implemented apps for a first user;
in response to receiving the data about the first condition, determining if one or more of a plurality of sets of required conditions are respectively satisfied by the first condition and at least one stored condition for the first user, each set of required conditions comprising one or more required conditions, each set of required conditions being associated with the delivery of content; and
causing first content to be provided to a computer device associated with the first user in response to determining by the at least one processor that all the required conditions of at least one set of required conditions have been satisfied, the first content being associated with the respective set of required conditions which is satisfied.

23. A non-transitory computer readable medium encoded with instructions for controlling a computer device having a display, in which the instructions when executed on a processor enable the processor to execute the steps of:
receiving an input indicating content which is to be provided in one or more computer implemented apps, a set of eligible users and a set of conditions to be satisfied in order to provide the content; and
generating from the input a computer model which comprises for each content a set of input conditions to be satisfied to provide the content and for at least one content, one or more output conditions providing one or more input conditions for one or more other sets of input conditions for a respective different content.

24. A computer apparatus comprising:
an input configured to receive, an input indicating content which is to be provided in one or more computer implemented apps, a set of eligible users and a set of conditions to be satisfied in order to provide the content; and
at least one processor configured to generate, from the input a computer model which comprises for each content a set of input conditions to be satisfied to provide the content and for at least one content, one or more output conditions providing one or more input conditions for one or more other sets of input conditions for a respective different content.

25. A computer apparatus comprising:
an input configured to receive data about a first condition associated with one or more computer implemented apps for a first user; and
at least one processor configured to, in response to receiving the data about the first condition, determine if one or more of a plurality of sets of required conditions are respectively satisfied by the first condition and at least one stored condition for the first user, each set of required conditions comprising one or more required conditions, each set of required conditions being associated with the delivery of content and cause first content to be provided to a computer device associated with the first user in response to determining by the at least one processor that all the required conditions of at least one set of required conditions have been satisfied, the first content being associated with the respective set of required conditions which is satisfied.
